(19) United States
(12) Patent Application Publication
(10) Pub. No.: US 2020/0340452 A1
(43) Pub. Date: Oct. 29, 2020

(54) TOWER, IN PARTICULAR FOR A WIND TURBINE

(71) Applicant: NOTUS ENERGY PLAN GMBH & CO. KG, POTSDAM (DE)

(72) Inventors: MARTIN DRIESCHNER, BERLIN (DE); YURIY PETRYNA, BERLIN (DE); BODO KOEPKE, BERLIN (DE); TILO STEINER, STRALSUND (DE); STEVE ROMER, STRALSUND (DE); GUNNAR GRAWE, POTSDAM (DE)

(73) Assignee: NOTUS ENERGY PLAN GMBH & CO. KG, POTSDAM (DE)

(21) Appl. No.: 16/753,853

(22) PCT Filed: Oct. 2, 2018
(86) PCT No.: PCT/EP2018/076866

§ 371 Date: Apr. 6, 2020

(30) Foreign Application Priority Data
Oct. 5, 2017 (EP) 17195043.9

(51) Int. Cl. F03D 13/20; E04H 12/08

(52) U.S. Cl. CPC F03D 13/20; E04H 2012/006; E04H 12/08

(57) ABSTRACT

A tower, in particular for a wind turbine, may have an upper tubular tower portion and a lower lattice-like tower portion. The lower tower portion may have at least three support members. The tower may also have a transition piece connecting the upper tower portion to the lower tower portion. The support members may be arranged substantially around a vertical longitudinal axis, including rotationally symmetrically about the central longitudinal axis. Each of the support members may have at least two portions inclined relative to the perpendicular. In a first, upper of the portions the support members may enclose an angle α with the perpendicular. In a second, lower of the portions the support members may enclose an angle β with the perpendicular. The angle β may be smaller than the angle α.

The invention relates to a tower, in particular a tower for a wind turbine, comprising an upper tubular tower portion, a transition piece, and a lower, for example lattice-like, tower portion.

Towers for onshore wind turbines are typically embodied as tubular towers, in particular steel tubular towers. This design, also referred to as a shell construction, has the advantage that the tubular towers consist of individual parts that may be assembled together so that the individual tower components are transportable. Transportability is a limiting factor in particular with regard to tower height, since with tower heights of more than 120 m a lower diameter of the tubular tower would exceed 4.3 m. Diameters of more than 4.3 m, however, are transportable on roads only with great difficulty, since bridges above roads and motorways often have a corresponding maximum clearance height. Without additional measures, known onshore steel tubular towers are thus limited to tower heights of approximately 120 m.

Hybrid tower designs are known from the prior art. These have the advantage that the lower tower portions, which usually have larger diameters, are made of comparatively convenient individual parts that may be assembled together and form a lattice supporting structure, and the upper tower portions are formed as a steel tubular tower. This design, however, requires technically complex solutions, in particular for a transition between the lower, lattice-like structure and the upper, tubular structure. Particularly with tower heights of more than 120 m, primarily only towers that have a high material requirement or a complex or overdimensioned structure are known, which in particular are costly to produce or are only transportable with relative difficulty.

DE 10 2010 015 761 A1 for example describes a stand structure for an offshore wind turbine. The stand structure comprises a central pillar, foot elements, and radial struts, which extend between the central pillar and the foot elements. The radial struts are curved convexly over their entire extent, which entails a significant manufacturing effort and high production costs. DE 10 2010 015 761 A1 also does not appear to provide a solution for providing a transition to an upper tower portion optimized in respect of the flow of forces.

In view of the prior art, the object of the invention is to propose an alternative tower which enables a reliable force flow from an upper, tubular tower portion to a lower, lattice-like tower portion, and at the same time may be produced relatively economically.

This object is achieved by a tower according to claim 1. Advantageous embodiments and developments of the invention are described in the dependent claims.

The tower, in particular for a wind turbine, comprises an upper, tubular tower portion and a lower, lattice-like tower portion. The lower tower portion comprises at least three support members. The tower also comprises a transition piece connecting the upper tower portion to the lower tower portion.

The support members are arranged substantially around a vertical longitudinal axis, preferably rotationally symmetrically about the central longitudinal axis. Here, “substantially vertically” means that the support members extend from bottom to top relative to a horizontal foundation but have at least two angles of inclination relative to a vertical longitudinal axis which is orthogonal relative to the horizontal foundation. Each of the support members has at least two portions inclined relative to the perpendicular. In a first, upper of the portions the support members enclose an angle α with the perpendicular. In a second, lower of the portions the support members enclose an angle β with the perpendicular. The angles are measured such that in each case the smallest of the angles enclosed by the support member and the perpendicular is the angle α or β respectively. The angles α and β are thus typically acute angles, that is to say angles that are smaller than 90°. The absolute value of each of the angles α and β is greater than 0°. The angle β is smaller than the angle α. The angle α may be at least 30°, preferably at least 40°. The angle α may be at most be 90°, preferably at most 80°, particularly preferably at most 70°. The angle β is usually greater than 0° and smaller than the angle α. A support member preferably comprises so-called connection profiles on an upper edge, and these are described in greater detail further below.

Each of the support members may have, along its extent, a third portion which is inclined relative to the perpendicular. Each of the support members may enclose an angle β¹ with the perpendicular. The second portion lies typically between the first and the third portion. The angle β¹ may be smaller than the angle β. Linear support member portions can usually be manufactured more economically. A support member contour that is convex as considered from the longitudinal axis may have the advantage that wind loads, in particular those that occur at an upper end of the tower, may be better routed into the foundation, for example since stress peaks are avoided. Structural advantages of the convex support member structure and economic advantages of the linear support member may be combined by a linear approximation to a convex support member contour.

Each of the support members, along its extent beneath the third portion, may have at least one further portion, preferably n further portions, inclined relative to a perpendicular by an angle β¹⁺ⁿ. The angles β¹⁺ⁿ may describe a convex curve of the outer contour. The angle β¹⁺ⁿ in this case may be smaller than the angle β¹⁺ⁿ⁻¹ of the portion arranged above and adjacently to the further portion. The angle β¹⁺ⁿ lies typically in a portion that is beneath a portion, with the latter portion enclosing the angle β¹⁺ⁿ⁻¹ relative to the perpendicular. For example, a portion with the angle β¹⁺ⁿ⁻¹=β⁴ lies above a portion with the angle β¹⁺ⁿ=β⁵. In this example, n is for example equal to 4, and the angle β⁵ is smaller than the angle β⁴. A support member, along its extent, may thus have a convex form relative to a tower longitudinal axis, which convex form is approximated by linear portions. The portions, along the elongate extent of the support members, may alternatively or additionally have regions that are curved in part and are thus true convex regions.

Each of the support members may have, along its extent, a fourth portion which is inclined relative to the perpendicular. In the fourth portion each of the support members may enclose an angle γ with the perpendicular. The fourth portion may lie above, preferably directly above the first portion. Each of the support members, along its extent above the fourth portion, may have at least one further portion, preferably n further portions, inclined relative to the perpendicular by an angle γ¹⁺ⁿ. The angles γ¹⁺ⁿ may describe a concave curve of the outer contour. The angle γ¹⁺ⁿ may be smaller than the angle γ¹⁺ⁿ⁻¹ of the portion arranged beneath and adjacently to the further portion. The angle γ¹⁺ⁿ lies typically in a portion that lies above a portion, with the latter portion enclosing the angle γ¹⁺ⁿ⁻¹ relative to the perpendicular. For example, a portion with the angle γ¹⁺ⁿ⁻¹=γ⁴ lies beneath a portion with the angle γ¹⁺ⁿ=γ⁵. In this example, n is for example equal to 4, and the angle β⁵ is smaller than the angle β⁴. A support member, along its extent, may thus have a concave form relative to a tower longitudinal axis, which concave form is approximated by linear portions. The portions, along the elongate extent of the support members, may alternatively or additionally have regions that are curved in part and thus are true concave regions.

The angle γ is preferably smaller than the angle α. The support members may thus have an inflection point along their elongate extent. This inflection point may be approximated for example by three portions arranged successively from top to bottom. In this case the arrangement of the portion from top to bottom is as follows: the fourth portion, the first portion, the second portion. The first portion in this case may have the above-described angle α, which is greater than the angle β. The fourth portion may have the angle γ, which is likewise smaller than the angle α. The angle γ may preferably be the same as, or smaller than the angle β. The angle γ may be greater than 0°. The fourth portion may also be arranged on the upper, tubular tower portion. The first portion with the angle of inclination α then preferably lies in the region of the connection profiles, and the second portion with the angle of inclination β then preferably lies beneath the connection profiles. The fourth portion may also be arranged in the region of the transition piece. The fourth portion, the first portion and the third portion may also all be arranged in the region of the connection profiles. The fourth portion, the first portion and the third portion may also all be arranged below the connection profiles.

The upper tower portion is typically formed as a supporting structure in the form of a shell. The lower tower portion is usually formed as a lattice-like supporting structure formed of rods. Supporting structures in the form of a shell are relatively favorable, but, in the case of large diameters greater than approximately 4.3 m, may only be transported with great additional outlay, for example by longitudinal separation of the segments. Supporting structures formed of rods have the advantage that large structures may be assembled from relatively small individual parts.

The supporting structure has been developed in particular for very large hub heights and may have a hub height of at least 120 m, preferably at least 140 m, preferably at least 160 m, and/or at most 300 m. The height is preferably measured from an upper edge of a foundation to an upper edge of the upper tower portion. The tower may have a shorter hub height, in particular in the case of offshore applications. Such high hub heights may be realized in particular by the specific form of the lattice structure of the lower tower portion and/or by the transition piece and/or by a foundation described below. With such hub heights, large forces and torques typically occur and must be withstood by the tower. Of course, the tower may also be used for other purposes, for example as a transmission tower.

The height of the lower, lattice-like tower portion may correspond to at least three times, advantageously at least more than three times, preferably at least four times a maximum lateral extent of the lower, lattice-like tower portion. Much smaller ratios are also possible, depending on the system configuration. This is particularly advantageous in order to withstand the above-described high loads in the case of tall tower heights. The height is preferably measured from an upper edge of a foundation to a lower edge of the upper, tubular tower portion. It has been found that a structure which is much broader than it is tall is not necessarily able to withstand higher loads. This may be attributed in particular to unpredictable synergy effects between the transition piece, the particular outer contour, the lattice structure, the specific value ranges of the lattice structure, the support member form and/or foundation form. Due to the above-described ratio, in particular material (and land sealing) may thus be reduced as compared to the prior art, high hub heights may be achieved, and very high loads may be withstood.

The support members, for example in a cross-section perpendicular to the longitudinal axis, at a lower edge of the connection profiles of the lower tower portion, may be at a radial distance from the longitudinal axis of at least 4 m, preferably at least 6 m, particularly preferably at least 8 m and/or at most 16 m. The lower edge of the connection profiles of the lower tower portion is preferably arranged at the height at which at least a highest cross strut of the lower tower portion along the central longitudinal axis is arranged. The cross strut, in its elongate extent, may be arranged substantially parallel to the horizontal. The lower edge of the connection profiles of the lower tower portion typically has a distance of at least 70 m from a foundation upper edge.

The support members, in a cross-section perpendicular to the tower longitudinal axis, at a lower edge of the lower tower portion, may be at a radial distance from the longitudinal axis of at least 5 m, preferably at least 7 m, particularly preferably at least 9 m or for example at least 10 m, and/or at most 20 m. The lower edge of the lower tower portion is preferably defined here by the height along the central longitudinal axis at which the support members are adjacent to the foundation. The lower edge of the lower tower portion lies typically on the upper edge of the foundation, that is to say on the foundation upper edge. The central longitudinal axis of the tower may correspond to the tower longitudinal axis. This arrangement of the support members may have the advantage that the support members may pass high forces into the foundation. High tower heights, which for example are exposed to high wind loads, may thus be realized.

The radial distance at the upper edge of the lower tower portion is typically smaller than the radial distance at the lower edge of the lower tower portion.

In one embodiment, the tower may have a strip foundation. A strip foundation may have the advantage that a ground area which lies within the strip foundation or also line foundation does not have to be concreted. Thus, the area occupied by the strip foundation may for example reduce land sealing and therefore compensation measures. Due to the advantageous strip foundation, the land sealing may be reduced by more than 40% as compared to conventional foundations for wind turbines. Furthermore, material may be saved by means of a strip foundation, and therefore costs may be lowered. Alternatively, the foundation may also be formed in the manner of individual foundations in order make further cost savings or in order to provide improved accessibility of the area demarcated by the foundation. In this case the number of the individual foundations corresponds preferably to the number of the support members. Foundations in the form of surface and/or deep foundations are possible. Each of the support members may be supported by a corresponding foundation. The force-locked and frictional connection between the support members and the foundation may be realized in the manner typical for machine foundations.

The line foundation or strip foundation may have a polygonal or circular shape. Of course, other foundations which are not formed as a line foundation are also possible.

The foundation, in particular the line foundation, may have a radial extent or a mean radial extent of at least 7 m, preferably at least 9 m. The radial extent may be measured for example at the foundation upper edge perpendicularly to the central longitudinal axis. The radial extent, for example in the case of a circular line foundation, may describe an outer radius of the line foundation.

A lower edge of the upper tower portion usually corresponds to an upper edge of the transition piece. The lower edge of the upper tower portion is typically connected to the upper edge of the transition piece, for example by means of a flange connection. A lower edge of the upper tower portion, or an upper edge of the transition piece, is typically arranged at a height along the longitudinal axis of at least 55 m above the foundation upper edge, preferably at least 80 m above the foundation upper edge.

The circumradius through centroids of the support members at the lower end of the connection profiles 8′ is at least 250%, preferably at least 350% of the circumradius of the shell middle plane at the lower edge of the upper, tubular tower cross-section.

The transition piece and/or the support members may have regions which are curved substantially inwardly towards the longitudinal axis. This usually corresponds to a partial concave curvature. The support members, in particular the connection profiles, may additionally or alternatively be curved outwardly, that is to say away from the central longitudinal axis. This usually corresponds to a partial convex curvature. The convex and/or the concave curvature may be approximated in each case by straight portions, as already described above. A curved form may have the advantage of a continuous force flow. Stress peaks and stress concentrations may thus be counteracted.

The support members, as already mentioned above, may comprise connection profiles for connection of the support members to the transition piece. Each of the connection profiles, in a cross-section along a connection profile longitudinal axis, may have an outer contour running from top to bottom along an elongate extent, preferably continuously, and having an inflection point. This may be the case in particular if the connection profiles, along their extent, have a concave and convex curvature, for example the connection profiles, along their extent from top to bottom, initially have a concave region and then a convex region. The outer wall of the connection profiles may be curved both about the connection profile longitudinal axis as well as along the connection profile longitudinal axis. The connection profiles may be formed as a conical tube. The conical tube may taper toward the bottom. The connection profiles may also have a constant cross-section. The connection profiles may also have a cross-section that has the form of a polygon. The cross-section of the connection profiles may also have concave or convex regions. The connection profiles may also have a curved outer wall on a first outer wall which is arranged closer to the tower longitudinal axis, and may have a flat outer wall on an outer wall which is arranged further away from the tower longitudinal axis, or vice versa. The connection profile longitudinal axis may also have an inflection point. The connection profile longitudinal axis is typically the line that connects the center points of the connection profile cross-sectional areas. The cross-sections are, for example, perpendicular to the connection profile outer contour or perpendicular to at least one connection profile outer wall.

The upper tower portion may have a height that corresponds at least to the length of a rotor blade path of movement. The length of a rotor blade is preferably at least 54 m. The lower tower portion preferably reaches below the rotor blade path of movement. The lower end of the connection profiles 8′ may be at a distance from the rotor blade path of movement of at least 6 m, preferably at least 8 m.

The transition piece is connectable to an upper, tubular tower portion and to the connection profiles. In order to connect the transition piece to the upper tower portion, the transition piece comprises an upper connection element. The upper connection element is formed in this case for example as a flange, preferably as a ring flange.

The transition piece further has a hollow structure which tapers towards the bottom. A lateral extent of the transition piece, i.e. an extent that is orthogonal to the longitudinal axis of the transition piece, decreases from the top toward the bottom.

The hollow structure may have a lower polygonal base area. The lower base area may also be configured to be round. The hollow structure may further have a round upper base area or polygonal upper base area. In a hollow structure with a polygonal upper base area, the number of corners of the lower polygonal base area is preferably lower than the number of corners of the polygonal upper base area. In a further exemplary embodiment, the hollow structure may be configured to be in the form of a frustum of a cone and have an upper and a lower base area, each configured to be round.

The polygonal or round base areas described in this application are typically arranged rotationally symmetrically about the tower longitudinal axis.

The hollow structure may have an inner lateral surface. The inner lateral surface may, for example widen from the top towards the bottom. The inner lateral surface may for example be made of one or more several inner sheets, while the outer surface of the hollow structure may be made of outer sheets. This allows, for example, for a shell structure. It may also be provided for the hollow structure to comprise only one layer, i.e. the hollow structure may be configured as a single-layer shell. The outer lateral surface may then, for example, describe an outer side of a component forming the single shell, e.g. a sheet, and the inner lateral surface may describe the inner side of the component forming the single shell, e.g. the sheet. An outer side of this shell may have the same form as an inner surface of this shell. It may, however, also be provided that the shell is shaped such that an inner face has a different form than an outer surface of the shell. This may, for example, be realized by components cast as a shell.

The inner lateral surface may for example be configured in the form of a frustum of a cone such that the transition piece has an inner lateral surface widening toward the top in the form of a frustum of a cone. An upper base area is typically configured to be circular and a lower base area is also configured to be circular. A diameter of the lower base area is typically smaller than a diameter of the upper base area so that the inner lateral surface widens from the bottom toward the top. A lateral surface configured in this way may be advantageous in avoiding stress peaks on corners and edges and to thus optimize a force flow.

The frustoconical inner lateral surface, accordingly, may be an inner lateral surface of a hollow cone frustum, which at least in some regions may have an outer lateral surface in the form of a frustum of a cone. The hollow cone frustum may form a supporting structure of the transition piece. The upper tower portion, as is usual for steel tubular towers, preferably has a ring flange. The frustoconical inner lateral surface of the transition piece is typically arranged rotationally symmetrically about a cone frustum longitudinal axis.

The inner lateral surface may alternatively have a round upper base area and a polygonal lower base area. The transition from a polygonal lower base area up to the round base area may be smooth, such that the inner lateral surface may be configured to be substantially curved. The inner lateral surface may, however, also comprise edges and steps. Thus, a transition from the polygonal lower base area to the round upper base area may be realized in a more economical manner, e.g. by means of sheets adjoining one another.

The lower polygonal base area of the inner lateral surface or the hollow structure, or of the outer lateral surface, may for example be configured to be a triangle, a rectangle, a pentagon or a hexagon. The round upper base area of the inner lateral surface or the hollow structure, or of the outer lateral surface, may for example be configured to be circular or elliptical.

The base areas may be at least partially or entirely configured to be through-openings or be closed, for example by a sheet.

It may also be provided that the lower as well as the upper base area are configured to be polygonal. In this case, the polygonal upper base area typically has a higher number or corners than the polygonal lower base area. Thus, the polygonal upper base area may better approach a round shape of the upper tower portion.

The polygonal upper base area has, for example, at least five corners, preferably at least eight corners, particularly preferably at least twelve corners.

The hollow structure may have an exterior form that widens towards the top. The hollow structure may then, for example, at least in part have an outer lateral surface widening toward the top in the form of a frustum of a cone. The outer lateral surface may be configured such that a lower base area is polygonal and an upper base area is round or also polygonal. The upper or lower base area of the outer lateral surface may then have the form of the upper or lower base area of the inner lateral surface.

Die outer lateral surface of the transition piece may enclose an angle of at least 15°, preferably an angle of at least 20°, with the longitudinal axis of the outer lateral surface. This angle between the outer lateral surface and the longitudinal axis of the outer lateral surface may, for example, enclose at the most 45°, preferably at the most 60°.

The transition piece may further have at least one outer connection face for connecting the transition piece to the support members.

The at least one connection face is typically arranged at an outer side of the hollow structure and below the upper connection element.

The connection face may, for example, be configured to be a ring flange on the outer side of the transition piece. Moreover, connection face of various configurations may be provided. In an exemplary embodiment of the transition piece, the transition piece may have at least three outer connection faces which may be arranged on an outer side of the transition piece substantially rotationally symmetrically about the cone frustum longitudinal axis. The transition piece preferably has a plurality of collars which protrude on the outer side of the transition piece. The collar may have a closed form and for example may form a flange in the form of a frame. The connection face then forms a surface of the collar or flange. The collars are preferably formed integrally with the transition piece. The outer connection faces are consequently part of the transition piece. At each the outer connection faces, the transition piece is connectable to a connection profile of the lower tower portion. To this end, the connection profiles, for example, may have a flange, the form of which corresponds to the form of the collar, in particular to the connection faces. A surface of the flange of the connection profile may be placed against the connection face and may be connected thereto, for example by means of welded connections or screw connections. The connection profiles may also have a frame-like flange on an upper side, the form of said flange corresponding to the collar of the transition piece so that the frame-like flange of the connection profile is insertable, for example interlockingly, into the collar of the transition piece. Additionally or alternatively, an integrally bonded connection may be provided. The connection profiles may also be connectable to the transition piece by means of shear cleats. In this case, the frame-like flange may form the shear cleat.

The upper tubular tower portion may be formed for example as a steel tubular tower, in particular as a supporting structure in the form of a shell. The transition piece may be formed at least in part as a supporting structure in the form of a shell. The transition piece is typically formed predominantly as a supporting structure in the form of a shell. The transition piece may be a symbiosis (or advantageous fusion/combination) of supporting structure in the form of a shell and supporting structure formed of rods.

The transition piece may have an inspection opening. Installation and maintenance staff may thus enter inside the transition piece. An inspection opening may be provided for example on an underside of the transition piece. For example, a circular base area of the cone frustum may have a recess, which may serve as an inspection opening. A radius of a circular inspection opening may be designed in accordance with Rule 113-004 of the DGUV (German Social Accident Insurance Association), Annex 7, “Minimum Requirements for Access with Fall Arrest Personal Protective Equipment”. A radius is preferably at least 300 mm. Inspection openings may also be provided in the connection profiles and/or in the frustoconical lateral surface. Each of the connection profiles may have an inspection opening. Connection regions, for example screw flanges, between the transition piece and the connection profiles may thus be accessible for installation and maintenance staff.

The connection faces may protrude on the outer side of the transition piece. A plurality of collars may protrude from the outer side of the transition piece, and the collars may form at least three, preferably closed, protruding flanges in the form of a frame. The flanges may fully or partially frame a corresponding region of the outer side of the transition piece. The flanges, in a plan view, may have different forms, and for example may have a triangular, rectangular, square, circular, elliptical or polygonal form, or also a combination of these forms. A surface of these collars or frame-like flanges may form the corresponding connection face. The form of the connection face, as described above, preferably corresponds to a connection face of the connection profiles. The connection profiles may be connected to the transition piece at the connection faces for example by flange connections, shear cleats and/or by welded connections.

The outer side of the transition piece has typically elongate shapings between the connection faces. The shapings preferably extend from an upper side of the transition piece to an underside of the transition piece. The curvature of the embodiments is preferably continuous and in particular does not have any edges. Stress peaks in the transition piece may thus be avoided. The shaping, also referred to as a recess, may have a constant recess radius of curvature over the height of the transition piece. It is also possible that the radius of curvature of the shaping changes over the height of the transition piece. The radius of curvature is defined here as the radius of what is known as a circle of curvature, which best approximates the form of the shaping in a cross-section transverse to the longitudinal axis. The radius of curvature may be at least 0.2 m. The radius of curvature may also be at least 0.5 m. The radius of curvature is typically at most 1 m. The radius of curvature is preferably 0.5 m.

The transition piece may be formed integrally. For example, this may have the advantage that stability is increased and the installation effort is reduced. Nevertheless, the transition piece may also be separable. In such a case, the individual parts preferably may be screwed together or welded together. Interlocking connections for connection of the individual parts are also conceivable. Multi-part transition pieces may have the advantage that maximum dimensions are not limited by transport conditions, as already explained above.

The transition piece is suitable for towers that are used onshore and/or offshore. In an onshore application, the transition piece, along a longitudinal axis, preferably along the cone frustum axis, typically has a height of at least 2.5 m, preferably of at least 3 m. The transition piece may also have a maximum height along the longitudinal axis of 4.7 m, preferably of 4 m. This has the advantage that the transition piece, when already assembled or in a one-piece embodiment, is transportable relatively easily and may be transported on roads and under bridges overland. In an offshore application the height may be much greater, for example up to 7 m.

In one specific embodiment, the transition piece may have a total height along a longitudinal axis which corresponds to at least 50% of a diameter of the upper tower portion. The diameter of the upper tower portion is usually the diameter of the upper tower portion at a lower edge of the upper tower portion (without ring flanges). The total height of the transition piece may preferably correspond to at least 80% of the diameter of the upper tower portion. The total height of the transition piece typically corresponds to at most 150% of the diameter of the upper tower portion. Maximum transport dimensions may thus be observed, and at the same time stress peaks in the transition piece and/or in a tower comprising the transition piece are avoided. The transition piece may have much larger dimensions, particularly in offshore applications.

For improved transportability overland, the transition piece may typically have, perpendicularly to the longitudinal axis, a lateral extent of at least 3.5 m, preferably at least 4 m, and/or at most 5.5 m, preferably at most 4.5 m. The greatest lateral extent is usually on an upper side facing the tubular tower portion. The transition piece has its smallest lateral extent typically on an underside which faces the lower, lattice-like tower portion. The transition piece may have much greater lateral extents, particularly in offshore applications.

The transition piece may also have a lateral extent perpendicularly to the longitudinal axis, which in each position along the height of the transition piece corresponds to at least 0% of the diameter of the upper tower portion, in the region of the connection element to the upper tower portion preferably at least 105% of the diameter of the upper tower portion. The maximum lateral extent perpendicular to the longitudinal axis is typically, in each position along the height of the transition piece, at most 120% of the diameter of the upper tower portion. The diameter of the upper tower portion is usually the diameter of the upper tower portion at a lower edge of the upper tower portion. A good transportability overland may thus be achieved, in particular also on roads that have a clear width of only 5.5 m.

The connection profiles of the lower tower portion may form an upper portion of the support members. Each connection profile may have an upper flange, the surface of which corresponds to the connection faces of the transition piece in such a way that the corresponding connection profile may be flange-mounted at an upper edge to the transition piece at the connection faces. The connection profile may also have a lower connection element, for example a lower flange. The lower connection element may be formed for example in such a way that it is connectable to a lower support member portion, preferably in interlocking, integrally bonded and/or force-locked fashion. The connection profile may have an upper profile element, which is connectable to the transition piece, and a lower insert. An insert recess may be formed on an underside of the profile element and may correspond at least in some regions to an outer contour of the insert, in such a way that the insert may be connected interlockingly to the upper profile element. The insert may be connected to the upper profile element for example via one or more welded connections, preferably at least in some regions along the insert recess. The insert is typically connectable, preferably releasably, at its underside to a lower support member portion. A releasable connection, for example a screw connection, has the advantage that the transition piece and the connection profiles may be transported independently of one another and may be relatively easily assembled at a place of installation. A cross-section of the insert may preferably correspond to a cross-section of the lower support member portion. For example, a continuous force flow may thus be achieved, since a force offset is substantially avoided. In particular, the lower tower portion may have a lattice structure which comprises at least three support members extending over the length of the lower tower portion. The form of the insert may preferably correspond to a form of an upper end of the lower support member portions in such a way that the insert on its underside may be fitted onto the upper end of the lower support member portions, onto or into the upper end. The insert and the lower support member portions may also be connected by an integrally bonded connection, for example welding, an interlocking connection, for example by being fitted in or on, and/or a force-locked connection, for example be flange-mounting, screwing, riveting, or the like. The insert and the lower support member portions may additionally or alternatively be connected by means of thrust cleats. A lower support member portion may have, for example, a square profile with an edge length of 800 mm and a wall thickness of 25 mm. Each support member, in the lower support member portion in a cross-section perpendicular to a support member longitudinal axis, preferably has a lateral extent of at least 400 mm. A support member wall thickness in the lower support member portion is typically at least 10 mm, preferably at least 20 mm, and/or at most 60 mm. Of course, the support members may also have other profile forms, for example U-profiles, rectangular or round profiles.

The insert may have the task of ensuring a continuous transition from the profile element to the lower support member portion. The insert preferably has the dimensions of the lower support member portion following on subsequently below.

The connection profiles may have a cross-section that changes along the extent of the connection profiles, preferably continuously. It may be provided that a cross-section size and/or a cross-section shape change along the extent of the connection profile. In a cross-section, a connection profile in one specific embodiment has a triangular shape, widening upwardly. The upper triangle edge may be convex in this case. The lower tip of the triangle may be rounded, preferably concavely rounded. The side edges of the triangle may be of equal length or may have different lengths. The upper, preferably convex edge in a lateral extent may be longer than the lateral edges. The connection profiles may have a quadrangular or polygonal form in a cross-section. The form preferably widens towards the top in a cross-section. Quadrangular or polygonal cross-section forms may also have concave and/or convex regions. The connection profiles may be formed as a welded construction. The connection profiles may have welded-together wall panels with a wall thickness of at least 10 mm and/or at most 60 mm. The wall panels of a connection profile may have different wall thicknesses. A cross-sectional area of the connection profile, in a cross-section perpendicular to a longitudinal axis of the connection profile, preferably decreases from top to bottom along this longitudinal axis. This has the advantage that a force flow may be optimized and at the same time only as much material as is necessary is used. This may lead to material savings and thus to cost savings. The connection profiles typically have a length along their extent of at least 1 m, preferably at least 8 m and/or at most 12 m. In particular for offshore applications, the connection profiles may also have a length along their extent of more than 12 m.

At least one wall of the connection profile, in a cross-section perpendicular to a longitudinal axis of the connection profile, may have a convexly shaped outer contour at least in some regions. A force flow from the upper tower portion, via the transition piece, into the lower tower portion may thus be improved. Material may then be saved on account of such a force flow optimization.

At least one wall of the connection profile, in a cross-section perpendicular to a longitudinal axis of the connection profile, may have a concavely shaped outer contour at least in some regions. A force flow from the upper tower portion, via the transition piece, into the lower tower portion may thus be improved. Stress peaks may be avoided by such an optimization of the force flow, and material may be saved.

The at least one wall of the connection profile, in a cross-section perpendicular to a longitudinal axis of the connection profile, may have both a concavely shaped outer contour at least in some regions and a convexly shaped outer contour at least in some regions. Stress peaks may also be avoided by concavely curved forms.

The wall of the connection profile may be curved once or more. A multiple curvature of the connection profiles may be realized in particular by a first curvature, for example by a design of the connection profiles that is concave and/or convex along the longitudinal axis, in combination with a curvature perpendicular to the longitudinal axis of the connection profiles.

In order to save material, the connection profiles may preferably be hollow, at least in some sections.

In order to save material, the walls of the connection profiles may be provided with recesses. The recesses may, for example, be covered with thin-walled sheets in order to protect the interior of the connection profiles from weather exposure. The connection profiles may be configured to be braced sheet metal constructions in order to reduce the sheet thickness of the profile elements.

In particular in the case of an offshore application of the transition piece, the connection profiles may be formed integrally with the transition piece. The connection profiles, for example, may be welded to the transition piece instead of, or in addition to flange connections.

Exemplary embodiments will be explained in greater detail with reference to the following drawings.

In the drawings:

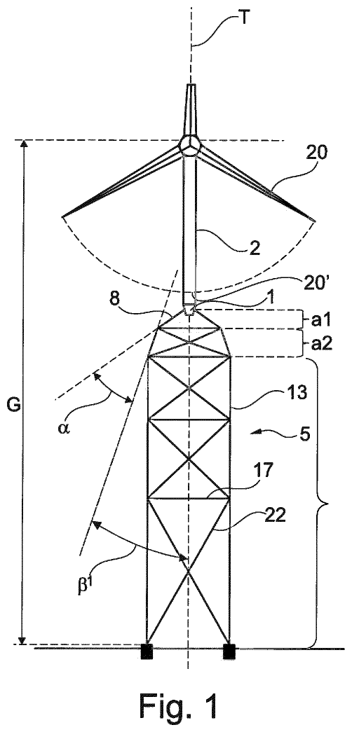

FIG. 1 shows a tower in a schematic view with a lower lattice-like tower portion and an upper, tubular tower portion;

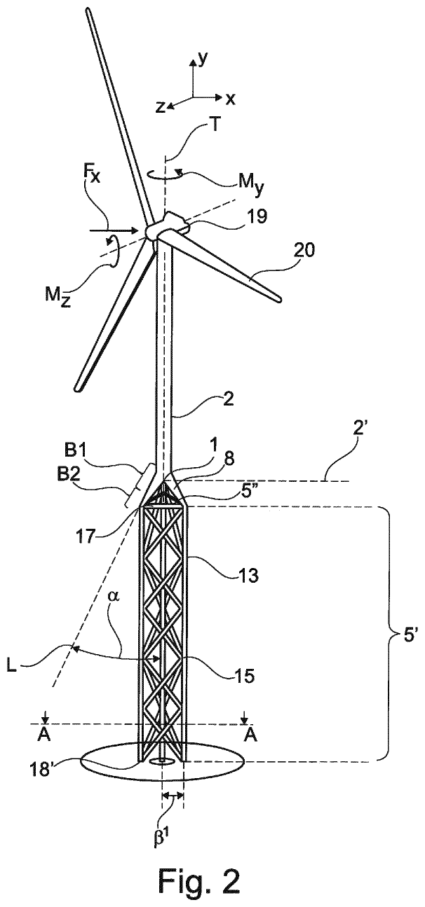

FIG. 2 shows the tower in a perspective view with a lower lattice-like tower portion and an upper, tubular tower portion, by way of example with a circular ring foundation;

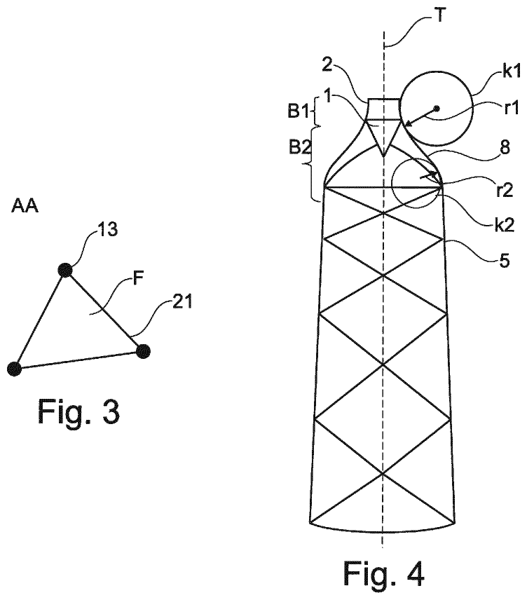

FIG. 3 shows a cross-section along the lines of section AA in FIG. 2;

FIG. 4 shows an exemplary form of a first transition region and a second transition region, preferably for a tower corresponding to FIG. 1;

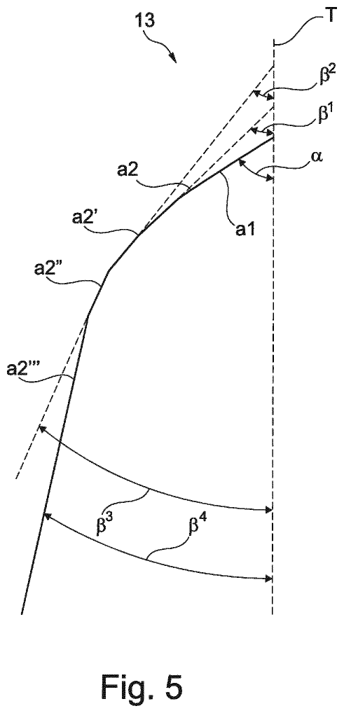

FIG. 5 shows an exemplary form of a support member;

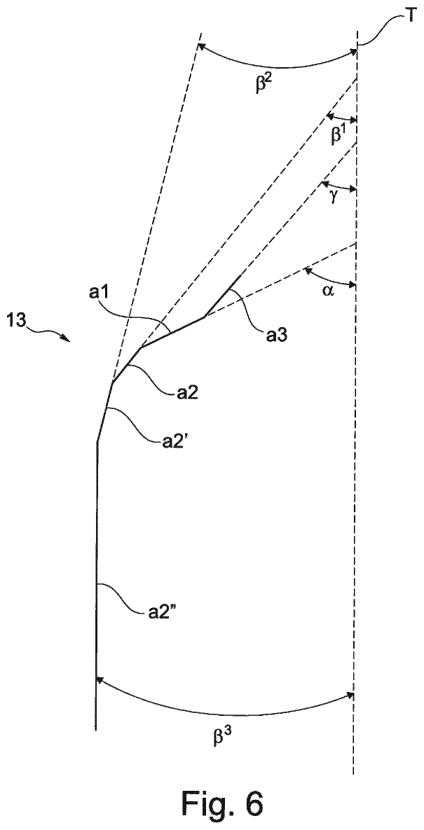

FIG. 6 shows a further exemplary embodiment of a support member;

FIG. 7 shows a transition piece in a perspective view;

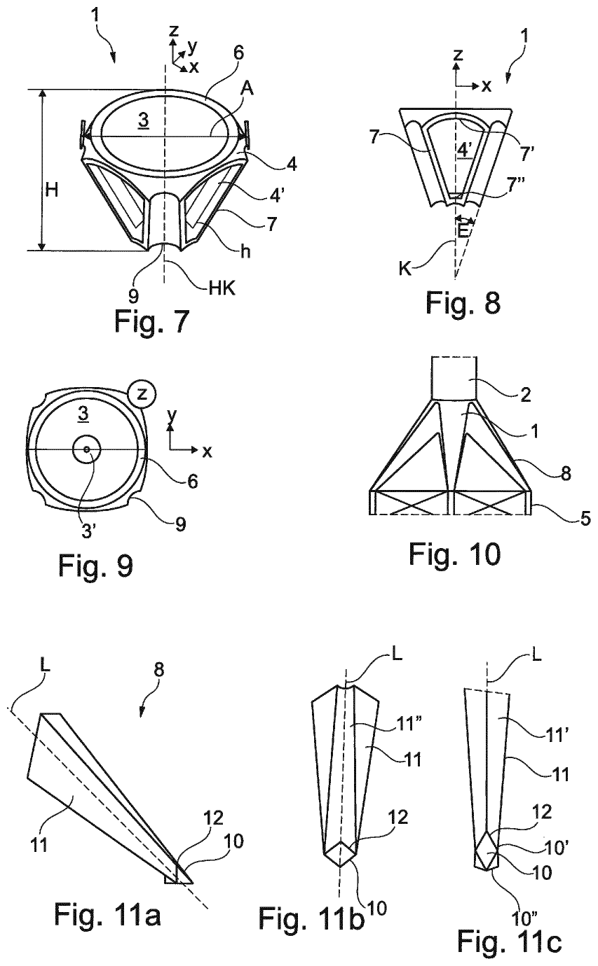

FIG. 8 shows the transition piece in a side view in an xz plane;

FIG. 9 shows the transition piece in a plan view in an xy plane;

FIG. 10 shows the transition piece connected to an upper tower portion and to connection profiles;

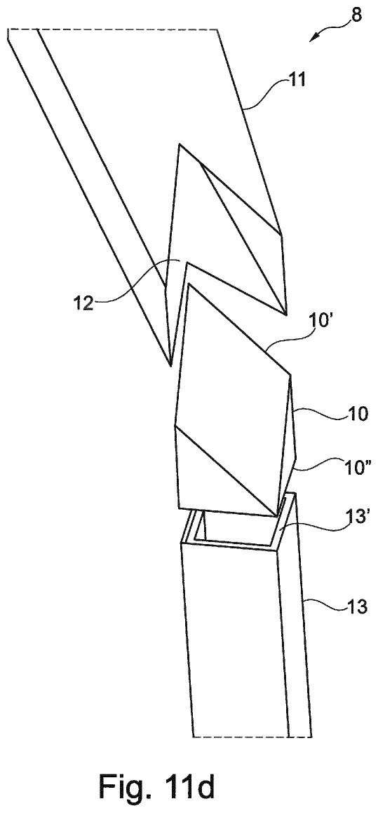

FIG. 11a-c shows one of the connection profiles in three difference views;

FIG. 11d shows an exploded view of a connection profile with an insert;

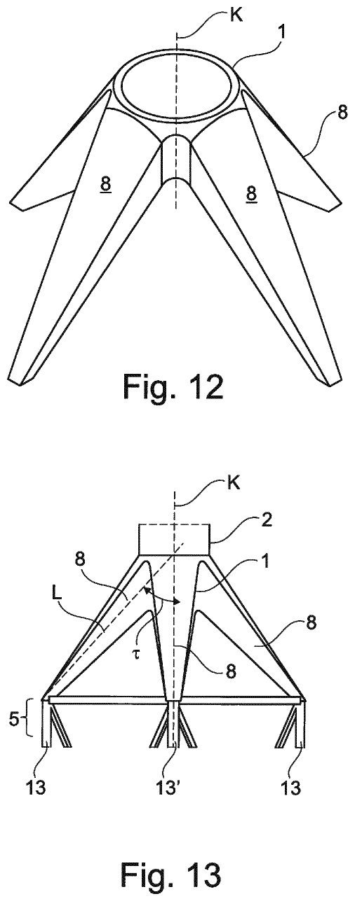

FIG. 12 shows the transition piece connected to four connection profiles;

FIG. 13 shows an upper tower portion, which is connected by means of the transition piece to the lower tower portion;

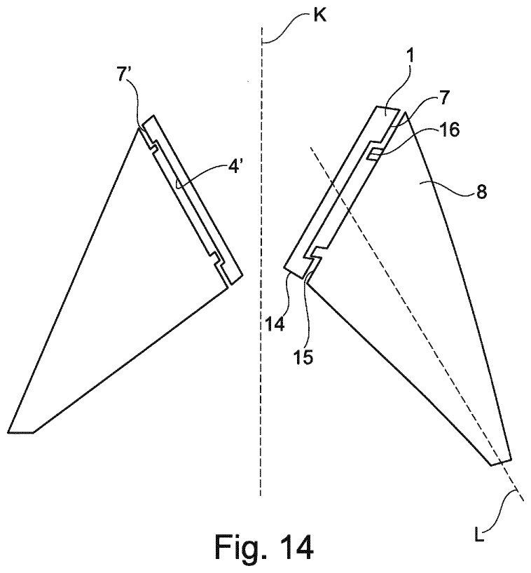

FIG. 14 shows a schematic view of a cross-section along the cone frustum longitudinal axis;

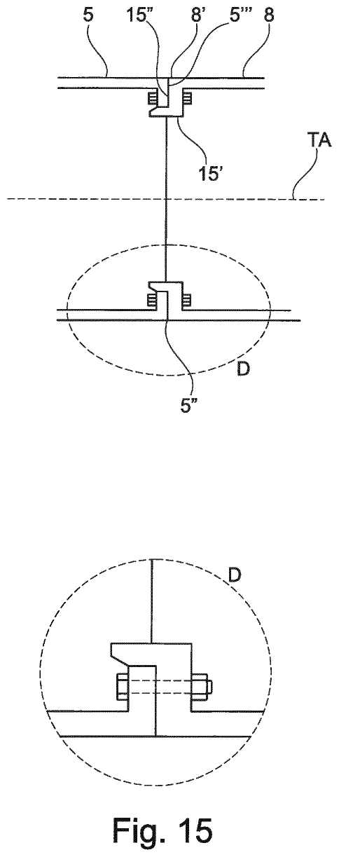

FIG. 15 shows a detailed view of a connection between the connection profile and the lower support member portion and/or the transition piece;

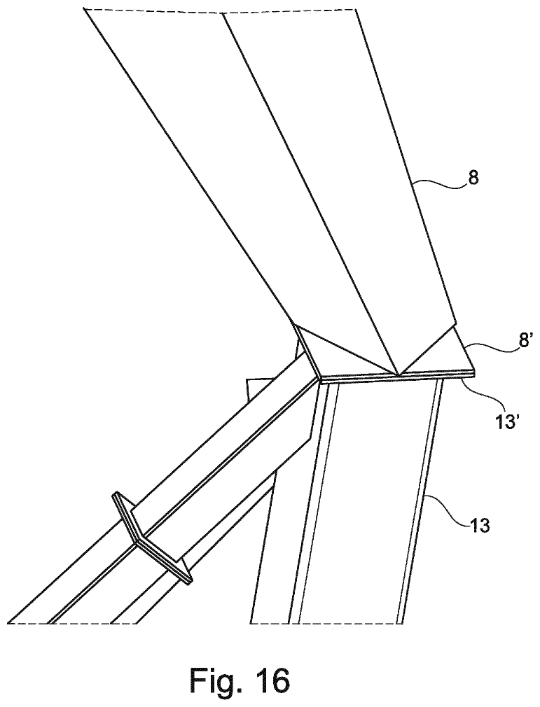

FIG. 16 shows a perspective view of a connection region between a connection profile, the lower support member portion and/or the transition piece.

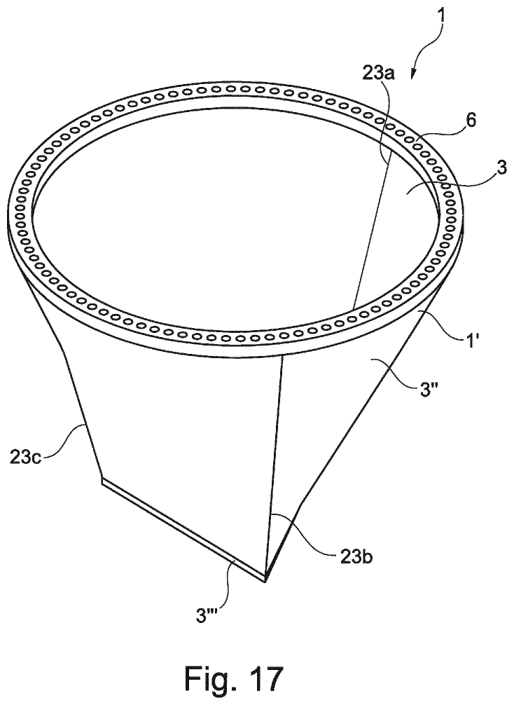

FIG. 17 shows a transition piece in a perspective view;

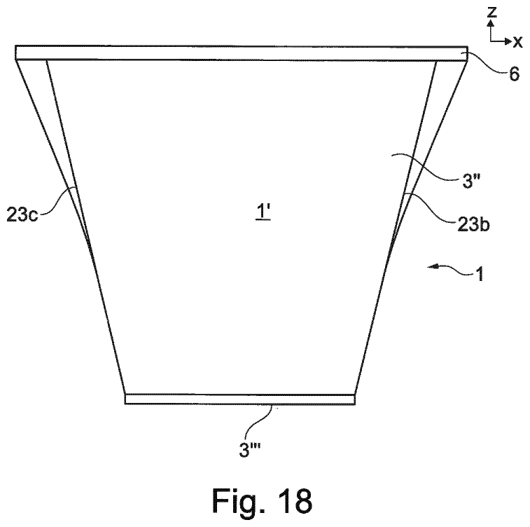

FIG. 18 shows the transition piece of FIG. 17 in a side view in an xz plane;

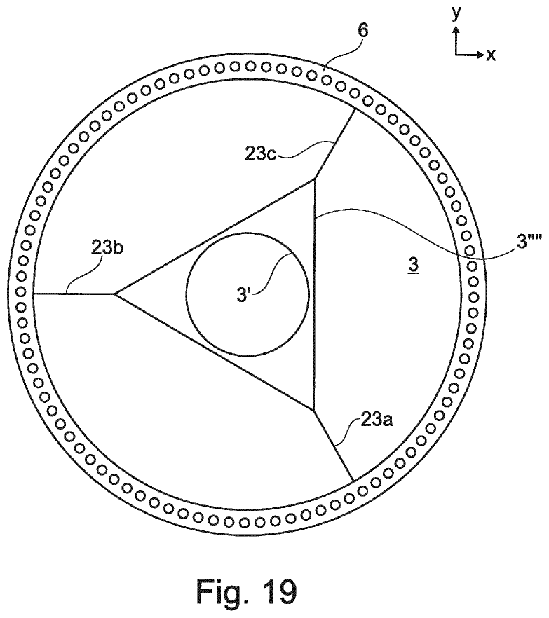

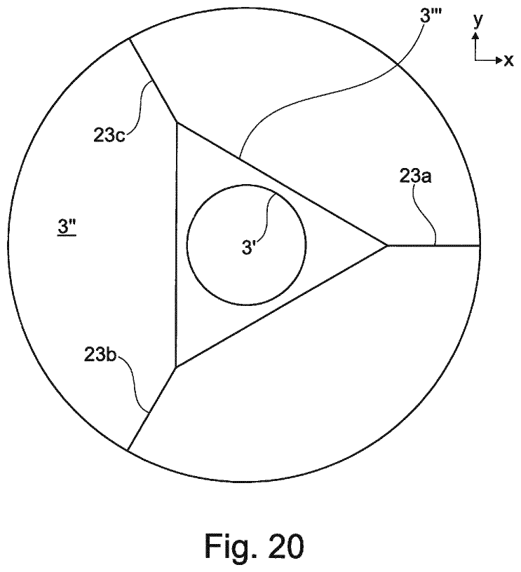

FIG. 19 shows the transition piece of FIGS. 17 and 18 in a plan view in an xy plane;

FIG. 20 shows the transition piece of FIGS. 17 to 19 in a view from below in an xy plane;

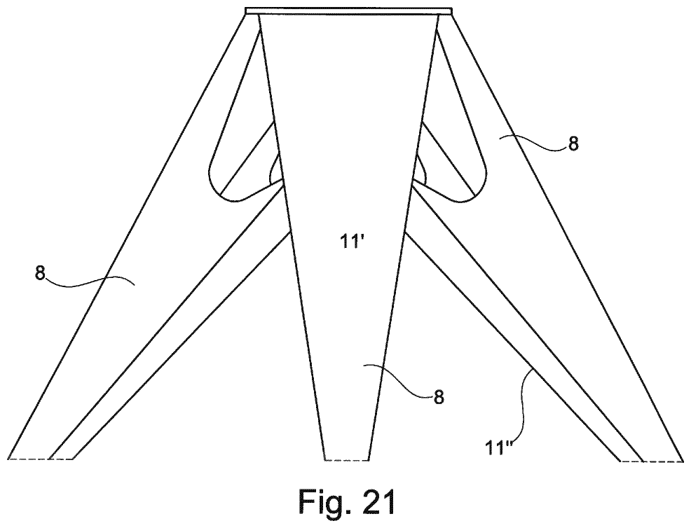

FIG. 21 shows the transition piece of FIGS. 17 to 20 with connection profiles in a side view;

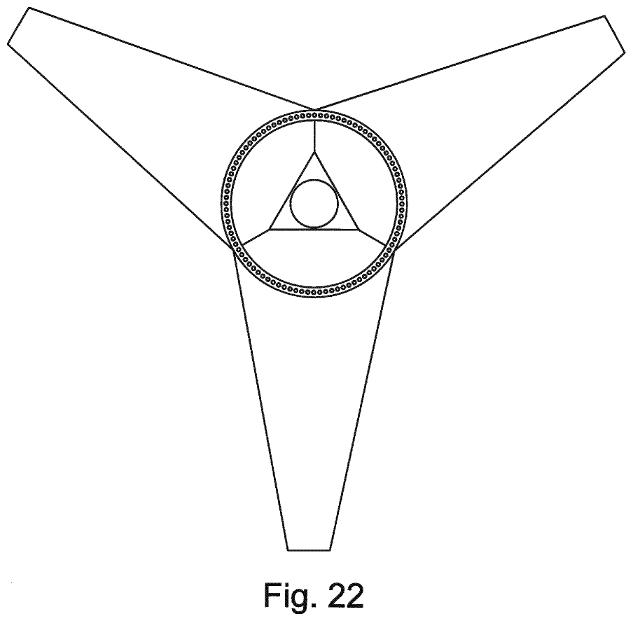

FIG. 22 shows the transition piece of FIGS. 17 to 20 with connection profiles in a plan view;

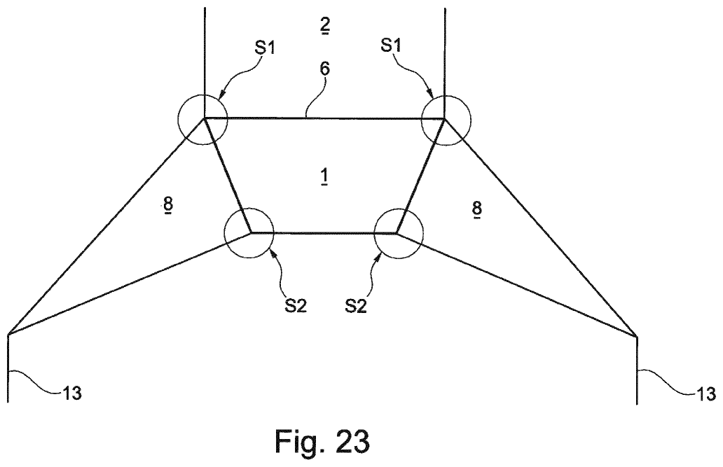

FIG. 23 shows a schematic drawing of a transition piece connected to an upper tower portion and, via connection profiles, to a lower tower portion.

FIG. 1 shows a schematic view of a tower for a wind turbine. The tower comprises a transition piece 1, an upper tower portion 2, which is formed in a tubular manner as a supporting structure in the form of a shell, and a lower tower portion 5, which is formed in a lattice-like manner, having at least three support members 13, in the form of a supporting structure formed of rods. The support members 13 are arranged rotationally symmetrically about a central tower longitudinal axis T. The transition piece 1 is arranged between the upper tower portion 2 and the lower tower portion 5. A rotor hub with rotor blades 20 is arranged on the upper tower portion. A rotor blade path of movement 20′ lies in the upper, tubular tower portion 2 above an upper edge of the transition piece 1. The tower has an overall tower height G of 158 m. Each of the support members 13 has a first, upper portion a1. In the first upper portion a1, each of the support members 13 encloses an angle α with the tower longitudinal axis. In the region of the first portion a1, each of the support members 13 is formed as a connection profile 8. The angle α in the shown exemplary embodiment is 42°. Each of the support members 13 has a second portion a2 arranged beneath the first portion a1. In the portion a2, each of the support members 13 encloses an angle β with the tower longitudinal axis T. In the exemplary embodiment shown, the angle β is 22° and is thus smaller than the angle α. In FIG. 1, each of the support members 13, in the lower part 5′ of the lower tower portion, has an angle of inclination β¹ relative to the central tower longitudinal axis T of 0°; in other embodiments β¹ may also be greater than 0°. A lower tower portion 5′ may thus be inclined relative to the tower longitudinal axis T. Furthermore, a plurality of portions which have an angle of inclination relative to the tower longitudinal axis may be arranged in the lower tower portion 5′. Each portion in the lower tower portion 5′ preferably has an angle of inclination that in each case is greater than an angle of inclination enclosed by the support member in the portion beneath and the tower longitudinal axis T. The lower tower portion 5 has cross-bracings 22 for strengthening. The tower also has cross struts 17. The lower, lattice-like tower portion may thus be braced. The lower tower portion is constructed in the manner of a supporting structure formed of rods.

FIG. 2 shows a perspective view of the tower for a wind turbine which corresponds substantially to that of FIG. 1 and differs from the tower in FIG. 1 in respect of details that will be described hereinafter. Any features of the towers shown in the following drawings may also be applied to the tower 1, and vice versa. A first transition region B1 describes the transition from the upper tower portion 2 to the transition piece 1. A second transition region B2 describes the transition from an upper part of the support members 13—the connection profile 8—to a lower part 5′ of the lower tower portion 5. The lower tower portion 5 has at least three cross struts 17. At the lower end of the connection profile 8′ of the lower tower portion 5, the support members 13 each have a radial distance perpendicularly to the longitudinal axis of 8 m. The lower end of the connection profiles 8′ has a distance to a foundation upper edge 18′ of a foundation 18 of 80 m. A lower edge of the upper tower portion has a distance of 90 m to the foundation upper edge 18′. A wind turbine 19 is mounted on an upper side of the upper tower portion. In this case, a hub of a rotor of the wind turbine has a distance to the foundation upper edge 18′ of 160 m. A rotor blade 20 has a length of 65 m. At the lower edge of the lower tower portion 5, that is to say at the foundation upper edge 18′, the support members have a radial distance of 10 m to the central tower longitudinal axis T. The upper, tubular tower portion 2 has a tube diameter of 4 m.

The tower is designed in such a way that it withstands subsequent extreme loads at hub height (coordinate system corresponding to FIG. 2); the described extreme load combination may act on the supporting structure from all directions, for which reason the coordinate system is rotated about the y-axis or the central tower longitudinal axis T:

### Fz=−1200 kN;

Fy=−2000 kN (substitute load for machine, nacelle, rotor, etc.);
My=+/−9000 kNm;

### Mx=+/−7500 kNm.

The total weight of the tower, without the foundation, is 438 t. The lattice structure of the lower tower portion 5 has steel profiles. A structural steel S 355 is preferred in this case. The cross strut 17 is a round profile with a diameter of 390 mm and a wall thickness of 17 mm. The support members are square hollow profiles. The support members have different material cross-sections along their extent. Each support member, at the foundation upper edge 18′, thus has a profile edge length of 793 mm and a wall thickness of 36 mm. At the height of the upper edge 17, each support member of the shown example has the same profile edge length of 793 mm, but a wall thickness of 25 mm. In other exemplary embodiments, the profile edge length and/or the wall thickness may of course vary over the extent of the support members. However, the wall thickness of the support members is preferably at least 20 mm and/or at most 60 mm. The support members may also have round cross-sections. The profile diameters may correspond to the above-mentioned profile edge lengths.

FIG. 3 shows a section AA of the tower of FIG. 1 or 2. The section AA represents a cross-section of the lower tower portion 5. The centroid of the support members 13 is described by a circumradius Ru. The circumradius Ru at the lower end of the connection profile is 8 m for the exemplary embodiment. The circumradius of the shell mid-surface at the lower edge of the upper tower portion is 2 m. The circumradius of the support members 13 at the lower end of the connection profiles 8′ is 4 times the circumradius of the shell mid-surface at a lower end of the upper tower portion.

FIG. 4 shows an exemplary form of a first transition region B1 and a second transition region B2, preferably for a tower corresponding to FIG. 1 or 2. The first transition region B1 has an inwardly curved surface relative to the central tower longitudinal axis T. The upper tower portion 2 is connected via the transition piece 1 to the connection profiles 8. The transition piece 1, the connection profiles 8, and the lattice-like structure of the lower tower portion 5 are merely shown schematically. A first radius of curvature r1 describes the radius of a circle k1 which best approximates the concave form of the first transition region B1.

The second transition region B2 has an outwardly curved surface relative to the central tower longitudinal axis T. The connection profiles 8 are connected in this region B2 to the lower tower portion 5. A circle k2 best approximates the convex curvature of the transition region B2. The circle k2 has a radius of curvature r2.

The radius of curvature r1 is preferably greater than the radius of curvature r2.

In one specific technical embodiment the radiuses of curvature are preferably approximated by straight elements. The connection profiles 8 may, however, also be curved.

FIG. 5 shows an exemplary embodiment of a support member 13. The support member 13 has a first, upper portion a1. In the portion a1, the support member 13 encloses an angle α with the tower longitudinal axis T. In a second portion a2, which is beneath the portion a1, the support member 13 encloses an angle β with the tower longitudinal axis T. The angle β is smaller than the angle α. In a further portion a2′, the support member encloses an angle β¹ with the tower longitudinal axis T. The angle β¹ is smaller than the angle β. In a portion a2″ beneath the portion a2′, the support member encloses an angle 32. The angle β² is smaller than the angle β¹. In a portion a2′″ beneath the portion a2″, the support member encloses an angle β³. The angle β³ is smaller than the angle β². In this way, the support member may, for example, approximate a convex curvature by means of linear portions. The portions a1, a2, a2′ and/or a2″ may lie in the region of the connection profile 8. However, they may also be arranged at least in part beneath the connection profile. In particular, the portion a1 is typically part of the connection profile.

FIG. 6 shows an exemplary embodiment of a support member 13. The support member 13 has a first, upper portion a1. In the portion a1, the support member 13 encloses an angle α with the tower longitudinal axis T. In a second portion a2, which is beneath the portion a1, the support member 13 encloses an angle β with the tower longitudinal axis T. The angle β is smaller than the angle α. In a further portion a2′, the support member encloses an angle β¹ with the tower longitudinal axis T. The angle β¹ is smaller than the angle β. In a portion a2″ beneath the portion a2′, the support member encloses an angle β². The angle β² is smaller than the angle β¹. In this way, the support member may, for example, approximate a convex curvature by means of linear portions. The portions a1, a2, a2′ and/or a2″ may lie in the region of the connection profile 8. However, they may also be arranged at least in part beneath the connection profile. In particular, the portion a1 is typically part of the connection profile.

The support member 13 also has a fourth portion a3. In the portion a3, the support member encloses an angle γ with the tower longitudinal axis T. The angle γ is smaller than the angle α. An inflection point thus lies on the support member. Each of the support members, along its extent above the portion a3, may have at least one further portion a3′ with the angle γ¹, preferably n further portions inclined relative to a perpendicular by an angle γ¹⁺ⁿ. The angle γ¹⁺ⁿ may be smaller than the angle γ¹⁺ⁿ⁻¹ of the portion arranged beneath and adjacently to the further portion. The support member, along its extent, may thus have a concave form relative to a tower longitudinal axis, which concave form is approximated by linear portions. The portions, along the elongate extent of the support members, may alternatively or additionally have regions that are curved in part and thus are true concave regions.

In the transition between the fourth portion a3 and the first portion a1, the form of the support member approximates a concave curvature. The form of the support member approximates a convex curvature between the portions a1, a2, a2′ and a2″. The portions a3, a1 and a2′ may all be part of the connection profile 8. The connection profile 8 may additionally also comprise the portion a2″. The portion a3 and n further portions above the portion a3 may be part of the connection profile 8 and/or part of the transition piece 1 and/or part of the upper tower portion 2.

In FIG. 7 the transition piece 1 for connection of the upper tower portion 2 to the lower tower portion 5 is shown. The transition piece 1 has an inner lateral surface 3, which widens upwardly in the form of a frustum of a cone, here in the z direction. The inner lateral surface 3 has a smooth surface. In the shown example a hollow cone frustum, that of the inner lateral surface 3, has a wall thickness of 40 mm. At an upper portion of the transition piece 1, the transition piece 1 has an upper connection element 6. Here, the upper connection element 6 is formed as a ring flange via which an upper tubular tower portion is connectable to the transition piece 1, in particular by screwing and/or welding. The transition piece 1 is rotationally symmetrical about a cone frustum longitudinal axis K. The transition piece 1 also has four outer connection faces 7 arranged on an outer side 4 rotationally symmetrically about the cone frustum longitudinal axis K. The connection faces 7 protrude from the outer side 4. The connection faces 7 preferably extend practically over the entire height of the transition piece 1. The connection faces 7 may form a flange which extends substantially from an upper end of the transition piece 1 to a lower end of the transition piece 1. The connection faces 7 may be connected to corresponding bearing faces of the connection profile 8 (see FIGS. 11a-11d). To this end, the connection profiles 8 may be screwed on and/or welded on, for example to the transition piece 1.

The connection faces 7 are, at least within a vertical projection of the connection profile longitudinal axis (L), arranged entirely below the connection element 6 and oriented in the force flow direction. This allows for a relatively simple force flow from the upper, tubular tower portion 2 to the support members 13. The transition piece has its maximum lateral extent on an upper side. The lateral extent of the transition piece decreases from the upper side to the lower side.

The outer side 4 of the transition piece 1 has elongate shapings 9 between the connection faces 7. In the shown example the shapings 9 extend from an upper edge of the transition piece 1 to a lower edge of the transition piece 1. In other embodiments the shapings may also extend only in some regions from an upper edge to a lower edge of the transition piece. The shapings 9 have a smooth inner face without edges or protrusions, such that stress peaks caused by notch stresses may be substantially avoided or reduced. The shown shapings 9 are curved inwardly (concavely) in the direction of the cone frustum longitudinal axis K. The form of the shown shaping 9 in FIG. 1, in a cross-section perpendicularly to the cone frustum longitudinal axis K, in this case may be elliptical or circular for example, at least in some regions. The outer contour of the transition piece in a cross-section perpendicular to the cone frustum longitudinal axis K may also describe a parabolic form in the region of the shaping.

The transition piece may consist, for example, of steel (for example structural steel S355), cast steel (for example nodular cast iron), reinforced concrete, fiber-plastics composite, or may contain combinations thereof. The transition piece is typically manufactured from steel. To this end, individual parts are usually cut to size, shaped, and joined together. The individual parts are typically joined together by welding; alternative possible joining methods, however, include screwing, riveting and adhesive bonding, for example.

The transition piece 1 in FIG. 7 has a maximum lateral extent A of 4.8 m. The height H of the transition piece 1 is 3.5 m. The connection face 7 protrudes with a collar height h of 20 cm relative to a framed outer side 4′ of the transition piece. In this case, the framed outer side 4′ is the outer side of the transition piece that is framed by the protruding connection faces 7. The framed outer side 4′ may have, in particular, the form of a region of an outer lateral surface of a cone frustum that widens towards the top. The framed outer side 4′, for example, in this case may constitute regions of an outer lateral surface of a cone frustum comprising the inner lateral surface 3. In the region of the framed outer sides 4′, the inner lateral surface 3 has a wall thickness of 40 mm.

FIG. 8 shows a side view of the transition piece 1 of FIG. 7 in the xz plane. The connection faces 7, in FIG. 2, lie in a plane that is inclined relative to the xz plane and that encloses an angle ε with the z axis. The connection faces 7 have a concavely rounded groove 7′ at an upper edge, and have a concavely rounded groove 7″ at a lower edge. The framed outer face 4′ is framed by the protruding connection faces 7.

FIG. 9 shows a plan view of the transition piece from above in an xy plane. Here, the inner lateral surface 3 is clearly visible. The cone frustum comprised by the inner lateral surface 3 has an opening 3′ at a lower end. The form of the opening 3′ corresponds here substantially to the lower circular base area of the cone frustum. A radius r of this circular opening 3′ corresponds in the shown example to a radius r′ of the four shapings 9. In other embodiments the radius r may be different from the radius r′ of the concavely rounded groove.

FIG. 10 shows a detail of a hybrid tower with an upper tubular tower portion 2, the transition piece 1, and a lower, lattice-like tower portion 5 with support members which are formed in an upper portion as connection profiles 8. The upper tower portion 2 is connected here to the transition piece 1 via the upper connection element 6, formed here as a ring flange, by means of screws. Furthermore, the transition piece 1, in particular with use of the transition piece 1 in a tower that is used in the offshore sector, may be connected at the connection faces 7 to the connection profiles 8 by welded connections. The connection profiles 8 are in turn connected at an underside to the lower portion 5′ of the support members. The connection profiles 8 and the connection of the connection profiles 8 to the lower portion 5′ of the support members will be explained in greater detail in particular in the following drawings.

FIGS. 11a to 11c show the connection profile 8 from different perspectives. FIG. 11a shows the connection profile in a perspective side view. FIG. 11b shows the connection profile 8 in a view from below; FIG. 11c shows the connection profile 8 in a view from above. The connection profile comprises a profile element 11 and an insert 10. On an underside of the profile element, an insert recess may be provided, which may correspond at least in some regions to an outer contour of the insert. The insert may thus be inserted with an accurate fit into the profile element and connected to the upper profile element. The insert preferably may be welded to the upper profile element at least in some regions along the insert recess. Additionally or alternatively, the insert may be connected to the profile element by means of plug-in connections, screw connections, snap-action connections and/or adhesively bonded connections. In one embodiment, the profile elements 11 may, entirely or in part, also be formed as a supporting structure formed of rods. The connection profile 8 is preferably hollow. In particular in the plan view of FIG. 5c, it is clear that the connection profile 8, here in particular the profile element 11, of the shown exemplary embodiment comprises a curved wall 11′, in particular a wall curved convexly about a longitudinal axis L. The profile element 11, on the side opposite the convexly curved wall 11′, also comprises a concavely curved wall 11″, that is to say a concavely curved groove. The profile element 11, however, may also have side edges which are not curved, as may be seen for example in FIG. 5a. The profile element 11 may also be curved along the longitudinal axis L, and therefore may have flat, single-curved and also double-curved walls. A cross-section of the connection profile 8 perpendicular to the longitudinal axis L may change continuously along its extent. A cross-sectional area of the connection profile 8 perpendicular to the longitudinal axis L typically decreases from top to bottom. Material may thus be saved since this is arranged depending on the effective loading. In this case, for example wind forces which act on an upper end of the upper tower portion are passed from the upper tower portion, through the transition piece 1, through the connection profiles 8, into the lower tower portion 5 and onwards into a foundation. The insert 10, as mentioned above, is preferably welded to the profile element 11 at a contour of the insert 10′ facing the profile element 11. At an underside 10″ of the insert, the insert typically has an opening, into which a lower support member portion 5′ may be inserted. A lower support member portion 5′ preferably may thus be connected to the insert with an accurate fit. It is additionally advantageous to releasably connect the support member to the insert by a flange connection, in particular by screwed flanges.

FIG. 11d shows the connection profile 8, which comprises the upper profile element 11 and the insert 10, and the support member 13 in an exploded view. The insert recess 12 corresponds to the contour 10′ of the insert 10 facing the profile element 11. The underside 10″ of the insert 10 is connectable to the lower support member portion 5′. The insert 10, to this end, has an L-flange on its underside 10″, which L-flange corresponds to a support member flange 13′. A connection of this kind is described in greater detail in FIG. 9.

FIG. 12 shows a perspective view of the transition piece with four connection profiles 8. In the shown example, four connection profiles are arranged rotationally symmetrically about the cone frustum longitudinal axis K. In another exemplary embodiment, only three or more than four connection profiles 8 may also be arranged about the cone frustum axis K. FIG. 13 shows a lower tower portion 5 which has four support members 13. The fourth support member is hidden in the view shown in FIG. 7 by the support member 13′. The number of the support members 13 and the number of the connection profiles 8 always match, since each connection profile 8, as described above, is part of the corresponding support member 13. A longitudinal axis L of the connection profile 8, in the shown example, encloses an angle α with the cone frustum axis K.

FIG. 14 shows a schematic view of a cross-section along the cone frustum longitudinal axis K of a transition piece 1 which corresponds substantially to that in the previous drawings. Four connection profiles 8 are connected to the transition piece. Four outer connection faces 7 of the transition piece 1 are arranged on an outer side 4 of the transition piece substantially rotationally symmetrically about the cone frustum longitudinal axis K. The transition piece has four collars 14, which protrude on the outer side 4 of the transition piece 1. Each collar 14 has a closed form in this case and forms a frame-like flange. The connection face in this case forms a surface of the collar 14, or frame-like flange. The collars 14 are formed integrally with the transition piece 1. At each of the outer connection faces 7, the transition piece 1 is connectable to a connection profile 8. To this end, the connection profiles 8 have a flange 15, the form of which corresponds to the form of the collar 14. A surface of the flange 15 of the connection profile 8 is placed against the connection face 7 and is connected thereto, for example by means of welded connections (in particular in the case of towers that are used offshore) or screw connections (in particular in the case of towers that are used onshore). The connection profiles 8 also have a frame-like flange 16 on an upper side, the form of said flange corresponding to the collar 14 of the transition piece in such a way that the frame 16 of the connection profile 8 is inserted with an accurate fit into the collar 14 of the transition piece 1.

FIG. 15 shows a detailed view of a connection between the lower support member portion 5′ of the lower tower portion 5, for example in the form of a supporting structure formed by rods, and the connection profile 8. FIG. 15 may also show a connection between the connection profile 8 and the transition piece 1. For the sake of clarity, the reference signs used in FIG. 15 correspond to those of a connection between the lower support member portion 5′ and the connection profile 8. The detailed view is shown in a cross-section along a support member longitudinal axis TA. Here, the connection profile 8, at its lower end 8′, has an inwardly protruding L-flange 15′. The L-flange 15′ may be arranged for example at the lower end 10″ of the insert 10. The L-flange 15′ has a bearing face 15″, against which a corresponding flange 5′″ of the lower tower portion 5 rests. The flange 5′″ is arranged on the uppermost support member 13 of the lower support member portion 5′. Due to the L form of the L-flange 15′, the connection profile 8 is insertable into the lower tower portion 5. The L-flange 15′ corresponds to the flange 5′″ of the lower support member portion 5′ in such a manner that the lower tower portion 5 is connectable to the connection profile 8 frictionally, for example by means of a flange connection. The L-flange 15′ and the flange 5′″ also have coaxial holes. A screw is inserted through the coaxially corresponding holes and is fixed by means of a nut. The lower support member portion 5′ and the connection profile 8 are thus additionally connected frictionally. The detailed view D shows this connection in an enlarged view. A connection of this kind may also be provided between the transition piece 1 and the connection profile 8. The transition piece 1 may thus be connected to the connection profile interlockingly and/or frictionally. To this end, the connection profile 8, at its upper end, has an above-described L-flange 15′, and the connection faces 7 of the transition piece 1 form a corresponding flange, which corresponds substantially to the flange 5′″ of the above description.

FIG. 16 shows, in a perspective view, a lower region of a connection profile 8, which is connected to a lower portion of the support member 13 via a flange connection. The shown connection profile 8 does not have an insert 10, but in another embodiment could also be formed having an insert 10. The shown connection profile 8, at a lower end 8′, has a flange in the form of a baseplate. This flange corresponds to a support member flange 13′ at the upper end of the lower support member portion 5′. The flange of the connection profile 8 rests flat on the support member flange 13′. The flanges, for example, may be connected by means of screw connections.

FIG. 17 shows an alternative transition piece 1 in a perspective view. The transition piece 1 has an upper connection element 6 in the form of ring flange. The transition piece further comprises a hollow structure which tapers towards the bottom, with an outer lateral surface 3″ which widens towards the top. The inner lateral surface 3 also widens towards the top. The upper base areas of the outer and the inner lateral surfaces are configured to be circular. The lower base area 3′″ of the outer lateral surface has a triangular shape. The lower base area 3′″ of the inner lateral surface 3″″ also has a triangular shape. The hollow structure 1′ is formed by three sheets which are welded to one another at the edges 23a, 23b, 23c. The sheets are each rounded in a manner such that a transition from the lower triangular shape to the upper circular shape is realized.

The outer lateral surface thus transitions/is reshaped from a lower base area in the shape of a polygon to a cone (positioned at the top). This construction (in this instance a single-layer shell) allows for a comparatively simple force flow from a connection face 6 to connection profiles 8. This also allows for a variable reaction to the number of support members 13 and connection profiles 8 and the amount of 3D-shaped sheets in the connection profiles 8 can be reduced significantly.

FIG. 18 shows the transition piece of FIG. 17 in a side view in an xz plane, FIG. 19 shows the transition piece of FIGS. 17 and 18 in a plan view in the xy plane. The triangular shape of the lower base area of the inner lateral surface is easily visible in the plan view. The transition piece further has an inspection opening 3′.

FIG. 20 shows the transition piece of the previous figures in a view from the bottom, such that the outer lateral surface 3″ is easily visible. The triangular shape of the base area 3′″ of the outer lateral surface 3″ and the inspection opening 3′ are also easily visible. Die outer lateral surface has a circular upper base area. The sheets of the hollow structure are bent three-dimensionally and adjoin one another in a manner such that the outer lateral surface widens towards the top and describes, in part, a smooth transition from a polygonal base area towards a circular base area at the top.

The other features described above, in particular with regard to the transition piece of FIGS. 7 to 10, may be combined with the transition piece of FIGS. 17 to 22.

FIG. 21 shows, in a side view, the transition piece of FIGS. 17 to 21, wherein connection profiles are connected to the transition piece. FIG. 22 shows the transition piece of FIGS. 17 to 20 with assembled connection profiles in a plan view. The connection profiles may, for example, be welded and/or screwed to the transition piece. A connection via adhesive bonding is also conceivable. The connection profiles of FIGS. 21 and 22 substantially correspond to the those of the figures described above. The connection profiles 8 have, inter alia, a convexly curved wall 11′ like the connection profiles of FIG. 11 and are configured to be hollow. Moreover, a cross section decreases from the top toward the bottom along the connection profile longitudinal axis L. However, the wall 11″ across from the wall 11′ is not curved concavely but configured to be flat, as opposed to the walls of the connection profiles of the figures above. The connection profiles further have side panels with recesses in order to save material and to reduce the weight of the connection profiles. In order to reduce the sheet thickness of the profile elements, the connection profiles 8 may be configured to be braced sheet metal constructions.

FIG. 23 shows a schematic view of a transition piece 1 according to the embodiments above, which transition piece is connected to an upper tubular tower portion 2 via the upper connection element 6. The transition piece 1 is connected to support members 13 of a lower, lattice-like tower portion via connection profiles 8. Due to its topology, the transition piece allows for a merging of the lower edge of the upper tubular tower portion 2, the upper side of the connection profile 8, the upper side of an outer lateral surface of the hollow structure and the upper connection element 6 at an upper panel edge S1 without significant offset. The transition piece further allows for merging of the lower edge of the connection profile 8 with the lower edge of the outer lateral surface of the hollow structure at a lower panel edge S2 without significant offset.

The application further comprises the following aspects:
1. A tower, in particular for a wind turbine, comprising an upper tubular tower portion (2) and a lower lattice-like tower portion (5) having at least three support members (13), and comprising a transition piece (1) connecting the upper tower portion (2) to the lower tower portion (5), wherein the support members (13) are arranged substantially around a vertical tower longitudinal axis (T), preferably rotationally symmetrically, wherein each of the support members (13) has at least two portions inclined relative to the perpendicular and in a first, upper of the portions (a1) encloses an angle α with the perpendicular, in a second, lower of the portions (a2) encloses an angle β with the perpendicular, and the angle β is smaller than the angle α.
2. The tower according to aspect 1, characterized in that each of the support members (13), along its extent, has a third portion (a2′) which is inclined relative to a perpendicular and in which each of the support members (13) encloses an angle β¹ with the perpendicular, wherein the second portion (a2) lies between the first portion (a1) and the third portion (a2′) and the angle β¹ is smaller than the angle β.
3. The tower according to aspect 1 or 2, characterized in that each of the support members (13), along its extent beneath the third portion (a2′), has at least one further, preferably n further portions inclined relative to a perpendicular by an angle β¹⁺ⁿ, wherein the angle β¹⁺ⁿ is smaller than the angle β¹⁺ⁿ⁻¹ the portion of arranged above and adjacently to the further portion.
4. The tower according to one of the previous aspects, characterized in that each of the support members (13) along its extent has a fourth portion which is inclined relative to a perpendicular and in which each of the support members (13) encloses an angle γ with the perpendicular, wherein the fourth portion lies above, preferably immediately above the first portion (a1) and the angle γ is smaller than the angle α.
5. The tower according to one of the previous aspects, characterized in that each of the support members (13) has, along its extent and above the fourth portion, at least one further, preferably n further portions inclined relative to a perpendicular by the angle γ¹⁺ⁿ, wherein the angle γ¹⁺ⁿ is smaller than an angle γ¹⁺ⁿ⁻¹ of a portion arranged beneath and adjacently to the further portion.
6. The tower according to any one of the preceding aspects, characterized in that the tower has a total height (G) of at least 120 m, preferably at least 140 m, preferably at least 160 m.
7. The tower according to any one of the preceding aspects, characterized in that the height of the lower, lattice-like tower portion (5) corresponds to at least three times, preferably at least four times a maximum longitudinal extent of the lower, lattice-like tower portion.
8. The tower according to any one of the preceding aspects, characterized in that the support members (13) in an upper support member portion have connection profiles (8) for connection of the support members (13) to the transition piece (1), wherein each of the connection profiles (8), at a lower edge, is at a radial distance from the tower longitudinal axis of at least 4 m, preferably at least 8 m and/or at most 16 m.
9. The tower according to any one of the preceding aspects, characterized in that a radial distance of the support members (13) from a tower longitudinal axis (T) at a lower edge of the lower, lattice-like tower portion is at least 5 m, preferably at least 10 m and/or at most 20 m.
10. The tower according to any one of the preceding aspects, characterized in that a circumradius (Ru) through centroids of the support member cross-sectional areas at a lower end of the connection profiles (8′) is at least 250%, preferably at least 350% of a circumradius of a shell middle plane at a lower edge of the upper, tubular tower cross-section.
11. The tower according to any one of the preceding aspects, characterized in that the upper tower portion (2) has a height that corresponds at least to the length of the rotor blade path of movement (20′), wherein the length of a rotor blade (20) is at least 40 m.
12. The tower according to any one of the preceding aspects, characterized in that the tower has a strip foundation (18) and/or individual foundations, which are arranged centrally beneath each of the support members (13).
13. The tower according to aspect 12, characterized in that the strip foundation (18) has a radial extent of at least 9 m, preferably at least 12 m.
14. The tower according to any one of the preceding aspects, characterized in that the upper tower portion (2) is formed as a supporting structure in the form of a shell and/or the lower tower portion (5) is formed as a supporting structure formed of rods.
15. The tower according to any one of the preceding aspects, characterized in that the transition piece (1) for connection of the upper tower portion to the lower tower portion comprises
   an upper connection element (6) to connect the transition piece (1) to the upper tower portion (2) and
   has an inner lateral surface (3) widening upwardly in the form of a frustum of a cone and
   at least three outer connection faces (7), which are arranged on an outer side (4) of the transition piece (1) substantially rotationally symmetrically about a cone frustum longitudinal axis and at which the transition piece (1) is connected to one each of the support members.
16. The tower according to aspects 12, characterized in that the transition piece (1) has elongate shapings (9) on the outer side (4) between the connection faces (7), which shapings preferably extend from a top side of the transition piece (1) to an underside of the transition piece (1).
17. The tower according to any one of the preceding aspects, characterized in that the transition piece (1) is formed integrally.
18. The tower according to any one of the preceding aspects, characterized in that the support members (13) have connection profiles (8) in an upper support member portion, for connection of the support members (13) to the transition piece, wherein a cross-section of each of the connection profiles (8) changes continuously along an elongate extent along a connection profile longitudinal axis (L) of the connection profile (8), preferably from the top toward the bottom.
19. The tower according to any one of the preceding aspects, characterized in that the support members (13) in an upper support member portion have connection profiles (8) for connection of the support members (13) to the transition piece, wherein each of the connection pieces (8), in a cross-section along a connection profile longitudinal axis (L), has an outer contour running, preferably continuously, from top to bottom along an elongate extent and having a turning point.

### LIST OF REFERENCE SIGNS

1 transition piece
1′ hollow structure
2 upper tubular tower portion
2′ lower edge of the transition piece
3 inner lateral surface
3′ opening
3 outer lateral surface
3′″ lower base area of the outer lateral surface
3″″ lower base area of the inner lateral surface
4 outer side
4′ framed outer side
5 lower lattice-like tower portion
5′ lower support member portion
5′″ flange at the upper edge of the lower tower portion
6 upper connection element
7 connection face
7′ concavely rounded groove at upper edge
7″ concavely rounded groove at lower edge
8 connection profile
8′ lower end of the connection profile
9 elongate recess
10 insert
10′ the contour of the insert facing the profile element
10″ underside of the insert
11 profile element
11′ wall
12 insert recess
13 support member
13′ support member flange
14 collar of the transition piece
15 connection profile flange
15′ L-flange of the connection profile
15″ bearing face of the L-flange
16 frame-like flange
17 cross strut
18 foundation
18′ foundation surface
19 wind turbine
20 rotor blade
20′ rotor blade path of movement
21 connection lines
22 cross-bracings
23a, b, c edges
A lateral extent of the transition piece
a1 first, upper portion
a2 second, lower portion
B1 first transition region
B2 second transition region
G total tower height
H height of the transition piece
K cone frustum longitudinal axis
L connection profile longitudinal axis
T central tower longitudinal axis
TA support member longitudinal axis
r1 radius of curvature of the first circle of curvature
r2 radius of curvature of the second circle of curvature
Ru circumradius through the centroid of the support member cross-sections
αⁱ,β^{j},γ^{k} angle between support member and tower longitudinal axis, with i, j, k elements N+
ε angle between connection faces and cone frustum longitudinal axis
k1 first circle of curvature for the concave outer contour
k2 second circle of curvature for the convex outer contour
h collar height
r radius of the opening 3′
S1 upper panel edge
S2 lower panel edge

1-21. (canceled)

22. A tower, including a tower for a wind turbine, comprising an upper tubular tower portion and a lower lattice-like tower portion having at least three support members, and comprising a transition piece connecting the upper tower portion to the lower tower portion, wherein the support members are arranged substantially around a vertical tower longitudinal axis, including rotationally symmetrically, wherein each of the support members has at least two portions inclined relative to the perpendicular and including in a first, upper of the portions encloses an angle α with the perpendicular, including in a second, lower of the portions encloses an angle β with the perpendicular, and the angle β is smaller than the angle α,
wherein the transition piece for connection of the upper tower portion to the lower tower portion has
an upper connection element to connect the transition piece to the upper tower portion and
a hollow structure which tapers towards the bottom,
wherein the support members have connection profiles in an upper support member portion, for connection of the support members to the transition piece, wherein a cross-section of each of the connection profiles changes continuously along an elongate extent along a connection profile longitudinal axis of the connection profile, preferably from the top toward the bottom.

23. The tower according to claim 22, wherein the hollow structure has an inner lateral surface widening toward the top in the form of a frustum of a cone.

24. The tower according to claim 22, wherein the hollow structure has an inner lateral surface widening toward the top, wherein the inner lateral surface has a lower polygonal base area and an upper circular base area.

25. The tower according to claim 22, wherein the hollow structure has an inner lateral surface widening toward the top, wherein the inner lateral surface has a lower polygonal base area and an upper polygonal base area, wherein the lower polygonal base area has fewer corners than the upper polygonal base area.

26. The tower according to claim 22, wherein the hollow structure has an outer lateral surface widening toward the top in the form of a frustum of a cone.

27. The tower according to claim 22, wherein the hollow structure has an outer lateral surface widening toward the top, wherein the outer lateral surface has
a lower polygonal base area and
an upper circular base area or an upper polygonal base area,
wherein the lower polygonal base area has fewer corners than the upper polygonal base area.

28. The tower according to claim 22, wherein the tower has a total height of at least 120 meters.

29. The tower according to claim 22, wherein the height of the lower, lattice-like tower portion corresponds to more than at least three times a maximum longitudinal extent of the lower, lattice-like tower portion.

30. The tower according to claim 22, wherein the support members in an upper support member portion have connection profiles for connection of the support members to the transition piece, wherein each of the connection profiles, at a lower edge, is at a radial distance from the tower longitudinal axis of at least 6 meters.

31. The tower according to claim 22, wherein a radial distance of the support members from a tower longitudinal axis at a lower edge of the lower, lattice-like tower portion is at least 7 meters.

32. The tower according to claim 22, wherein a circumradius through centroids of the support member cross-sectional areas at a lower end of the connection profiles is at least 250% of a circumradius of a shell middle plane at a lower edge of the upper, tubular tower cross-section.

33. The tower according to claim 22, wherein the upper tower portion has a height that corresponds at least to the length of the rotor blade path of movement, wherein the length of a rotor blade is at least 40 meters.

34. The tower according to claim 22, wherein the tower has a strip foundation and/or individual foundations, which are arranged centrally beneath each of the support members.

35. The tower according to claim 34, wherein the strip foundation has a mean radial extent of at least 7 meters.

36. The tower according to claim 22, wherein the upper tower portion is formed as a supporting structure in the form of a shell and/or the lower tower portion is formed as a supporting structure formed of rods.

37. The tower according to claim 22, wherein the transition piece for connection of the upper tower portion to the lower tower portion comprises
at least three outer connection faces, which are arranged on an outer side of the transition piece substantially rotationally symmetrically about a cone frustum longitudinal axis and at which the transition piece is connected to one each of the support members.

38. The tower according to claim 37, wherein the connection faces are, at least within a vertical projection of the connection profile longitudinal axis, arranged entirely below the connection element.

39. The tower according to claim 38, wherein the transition piece has elongate shapings on the outer side between the connection faces, which shapings extend from a top side of the transition piece to a bottom side of the transition piece.

40. The tower according to claim 22, wherein the transition piece is formed integrally.

41. The tower according to claim 22, wherein the support members in an upper support member portion have connection profiles for connection of the support members to the transition piece, wherein each of the connection pieces, in a cross-section along a connection profile longitudinal axis, has an outer contour running, including continuously, from top to bottom along an elongate extent and having a turning point.

42. The tower according to claim 22, wherein each of the connection profiles (8) comprises side panels with recesses, including elongate recesses.
